(19) United States
(12) Patent Application Publication
(10) Pub. No.: US 2020/0380267 A1
(43) Pub. Date: Dec. 3, 2020

(54) OBJECT TRAJECTORY AUGMENTATION ON A NEWLY DISPLAYED VIDEO STREAM

(71) Applicant: Xinova, LLC, Seattle, WA (US)

(72) Inventor: Hyoung-Gon LEE, Gyeonggi-do (KR)

(73) Assignee: Xinova, LLC, Seattle, WA (US)

(21) Appl. No.: 16/957,459

(22) PCT Filed: Jan. 4, 2018
(86) PCT No.: PCT/US2018/012420

§ 371 Date: Jun. 24, 2020

(51) Int. Cl. G06K 9/00; G06T 7/223; H04N 7/18

(52) U.S. Cl. CPC G06K 9/00778; H04N 7/181; G06T 7/223; G06K 9/00342

(57) ABSTRACT

Technologies are generally described for object trajectory augmentation on a newly displayed video stream in surveillance environments. A surveillance system may derive and store motion vectors associated with multiple targets in videos captured in a surveillance environment. In some examples, the motion vectors may be derived through parsing of the captured videos without complete decoding. Upon selection of a particular video for display, one or more targets in the current video may be identified and their motion vectors derived. A trajectory of the target(s) may then be generated based on a match of motion vectors from the current video and stored motion vectors. The generated trajectory may be used to augment the current video providing an observer a past and/or future path for the identified target(s).

### BACKGROUND

Unless otherwise indicated herein, the materials described in this section are not prior art to the claims in this application and are not admitted to be prior art by inclusion in this section.

A surveillance system for large-scale events or venues may collect videos from a number of cameras and analyze them. However, due to the constraint of screen size or the number of videos to be displayed, a limited number of camera videos may be displayed on the screen(s) of a surveillance center. The displayed videos of different vantage points may be rotated, switched, and/or re-selected. As the displayed videos change, it may be difficult for observers (e.g., security personnel) to find singularities in a video as the observer may not know what has happened in a particular video scene. In other words, the observer may not know how a target in the video has acted or moved before the video is displayed.

### SUMMARY

The present disclosure generally describes techniques for object trajectory augmentation on a newly displayed video stream in surveillance environments.

According to some examples, a method to provide trajectory augmentation on a newly displayed video stream is described. The method may include receiving a captured video of a surveillance environment; identifying a target in the captured video; receiving motion vectors for a plurality of targets derived from previously captured videos; identifying at least one motion vector associated with the identified target among the received motion vectors; generating, based on the at least one motion vector, a trajectory for the identified target; and augmenting the captured video with the trajectory for the identified target.

According to other examples, an apparatus configured to provide trajectory augmentation on a newly displayed video stream is described. The apparatus may include a communication interface configured to facilitate communication between the apparatus, a plurality of cameras in a surveillance environment, and a data store; a plurality of parsers coupled to the communication interface and configured to parse captured video received by the communication interface from the plurality of cameras; and a processor coupled to the communication interface and the plurality of parsers. The processor may be configured to perform or control performance of identifying a target in the captured video; receive, through the communication interface, motion vectors for a plurality of targets derived from previously captured videos; identify, among the received motion vectors, at least one motion vector associated with the identified target; generate, based on the at least one motion vector, a trajectory for the identified target; and augment the captured video with the trajectory for the identified target.

According to further examples, a surveillance system configured to provide trajectory augmentation on a newly displayed video stream is described. The system may include a plurality of surveillance cameras in a surveillance environment; a data store configured to store surveillance related data; a workstation communicatively coupled to the plurality of surveillance cameras and to the data store, where the workstation includes a display device configured to display feeds from the plurality of surveillance cameras and the surveillance related data from the data store; and a server communicatively coupled to and configured to control the plurality of surveillance cameras, the data store, and the workstation. The server may include a communication interface configured to facilitate communication with the plurality of surveillance cameras, the data store, and the workstation; and a processor coupled to the communication interface. The processor may be configured to perform or control performance of receive, through the communication interface, a captured video of the surveillance environment; identify a target in the captured video; receive, through the communication interface, motion vectors for a plurality of targets derived from previously captured videos; identify, among the received motion vectors, at least one motion vector associated with the identified target; generate, based on the at least one motion vector, a trajectory for the identified target; and augment the captured video with the trajectory for the identified target.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 includes a conceptual illustration of an example environment, where object trajectory augmentation on a newly displayed video stream in surveillance environments may be implemented;

FIG. 2 includes a conceptual illustration of another example environment, where object trajectory augmentation on a newly displayed video stream in surveillance environments may be implemented;

FIG. 3 illustrates example components and interactions in a system for object trajectory augmentation on a newly displayed video stream in surveillance environments;

FIG. 4 illustrates conceptually a flow of actions in a system for object trajectory augmentation on a newly displayed video stream in surveillance environments;

FIG. 5 illustrates an example scenario for implementing object trajectory augmentation on a newly displayed video stream in surveillance environments;

FIG. 6 illustrates a computing device, which may be used for object trajectory augmentation on a newly displayed video stream in surveillance environments;

FIG. 7 is a flow diagram illustrating an example method for object trajectory augmentation on a newly displayed video stream in surveillance environments that may be performed by a computing device such as the computing device in FIG. 6; and

FIG. 8 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to object trajectory augmentation on a newly displayed video stream in surveillance environments.

Briefly stated, technologies are generally described for object trajectory augmentation on a newly displayed video stream in surveillance environments. A surveillance system may derive and store motion vectors associated with multiple targets in videos captured in a surveillance environment. In some examples, the motion vectors may be derived through parsing of the captured videos without complete decoding. In response to selection of a particular video for display, one or more targets in the current video may be identified and their motion vectors derived. A trajectory of the target(s) may then be generated based on a match of motion vectors from the current video and stored motion vectors. The generated trajectory may be used to augment the current video providing an observer a past and/or future path for the identified target(s).

In the following figures and diagrams, the positioning, structure, and configuration of example systems, devices, and implementation environments have been simplified for clarity. Embodiments are not limited to the configurations illustrated in the following figures and diagrams. Moreover, example embodiments are described using humans as tracking targets in specific example surveillance environments. Embodiments may also be implemented in other types of environment for tracking animals, vehicles, or other mobile objects using the principles described herein.

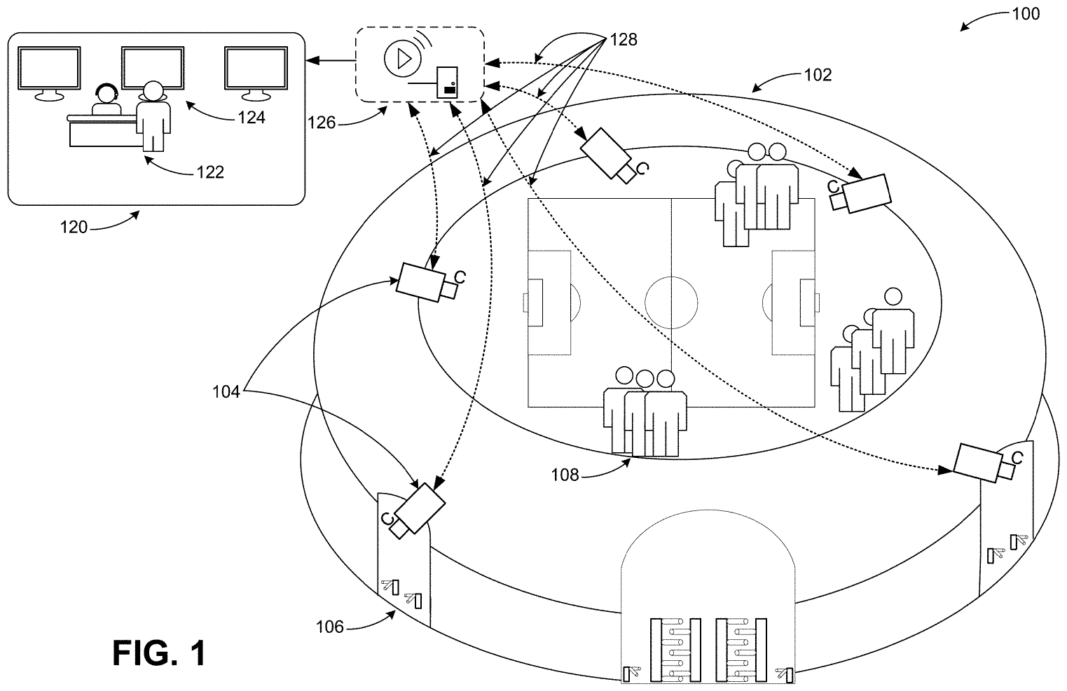

FIG. 1 includes a conceptual illustration of an example environment, where object trajectory augmentation on a newly displayed video stream in surveillance environments may be implemented, arranged in accordance with at least some embodiments described herein.

As shown in diagram 100, a surveillance system capable of object trajectory augmentation on a newly displayed video stream may include a control center 120, where personnel 122 may observe captured videos 128 of the surveillance environment 102 on display devices 124. The personnel 122 may select different videos from different image capture devices 104 at various times. The image capture devices 104 may be positioned to monitor crowds 108 in a plurality of areas such as entrances 106 of a stadium (surveillance environment 102). The image capture devices 104 may include a stationary camera, a mobile camera, a thermal camera, a camera integrated in a mobile device, or a body-mounted camera, for example. The image capture devices may capture a video signal corresponding to an area and may transmit the video signal to a server 126 to be processed.

As displayed videos of different vantage points are rotated, switched, and/or re-selected in a surveillance system, observers may not know how a target in the video has acted or moved before the video is displayed. A moving trajectory of a target in a video may be a helpful tool for personnel who monitor the surveillance videos. However, it may not be possible to know in advance which cameras are selected in sequence. For example, personnel in a surveillance center may manually select a particular camera and have corresponding video displayed on the screen.

One approach to display (or track) the prior movements (or trajectory) of a target may include storing all surveillance and decoding the previous moments of a selected video and to analyze the movements of the target. The identified movement information of the target may then be overlaid on a current video. However, in the case of large-scale events or venues, a number of cameras that capture videos may be high. Thus, storing, decoding, and analyzing the high number of videos may be prohibitively resource-expensive.

The surveillance system represented in diagram 100 may derive and store motion vectors associated with multiple targets in videos captured by image capture devices 104 in the surveillance environment 102. In response to selection of a particular video for display on one of the display devices 124 in the control center 120, one or more targets in the current video may be identified and their motion vectors derived by the server 126. A trajectory of the identified target(s) may then be generated based on matching of motion vectors from the current video and stored motion vectors. The generated trajectory may be used to augment the current video, thereby providing an observer a past and/or future path for the identified target(s).

Typical surveillance system configurations, as discussed above, rely on security personnel to observe one or more targets in a video signal and determine their movements and behavior manually. Providing object trajectory augmentation on a newly displayed video stream may allow for more reliable determination and prediction of target behavior, and may also allow security personnel in the field to be more aware of current and predicted target movements.

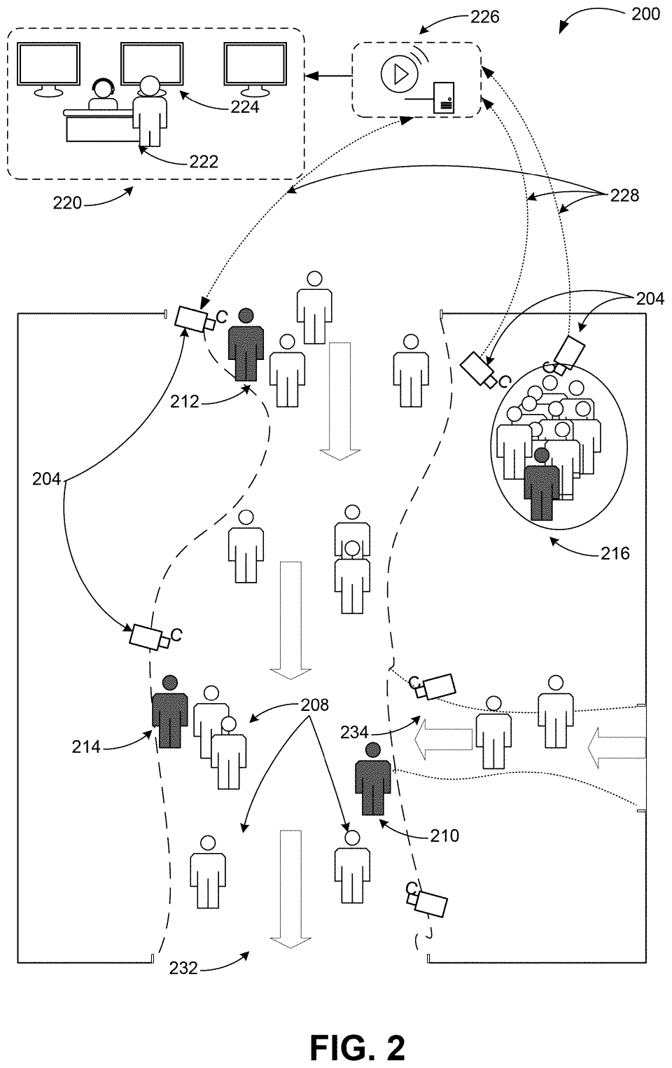

FIG. 2 includes a conceptual illustration of another example environment, where object trajectory augmentation on a newly displayed video stream in surveillance environments may be implemented, arranged in accordance with at least some embodiments described herein.

As shown in diagram 200, a surveillance system may include a control center 220, where personnel 222 may observe captured videos 228 of the surveillance environment on display devices 224. The personnel 222 may select different videos from different image capture devices 204 at various times. The image capture devices 204 may be positioned to monitor crowds 208 in a plurality of areas such as a main walkway 232 of a route in a large gathering, connection point 234, or other gathering areas 216, where crowds may congregate and target people 210, 212, 214 may be observed by the security personnel. Captured images or videos may be provided by the image capture devices 204 to a processing server 226, which may parse encoded video streams to derive motion vectors for multiple targets in each video stream and store the motion vectors in a quickly accessible data store.

Videos from a number of surveillance cameras may be transmitted to the processing server 226 through a network with a potentially limited capacity. Thus, surveillance videos may be transmitted in compressed or encoded format. By deriving the motion vectors from captured videos through parsing as opposed to complete decoding, the security system may not only reduce needed storage space and processing resource consumption, but also reduce processing and access times in an environment, where real-time information may be needed.

The security system may analyze the stored motion vectors to generate a trajectory for a target (or multiple targets) in a currently displayed video for a time period when the currently displayed video was not being displayed. The trajectory may also be extended into future based on the analysis results and used to augment the current video. Processing of captured videos, storage and retrieval of the derived motion vectors, and generation of the trajectory based on an analysis of stored motion vectors may be performed by the same processing server 226 or by different servers. The processes may also be executed by other computing devices or components.

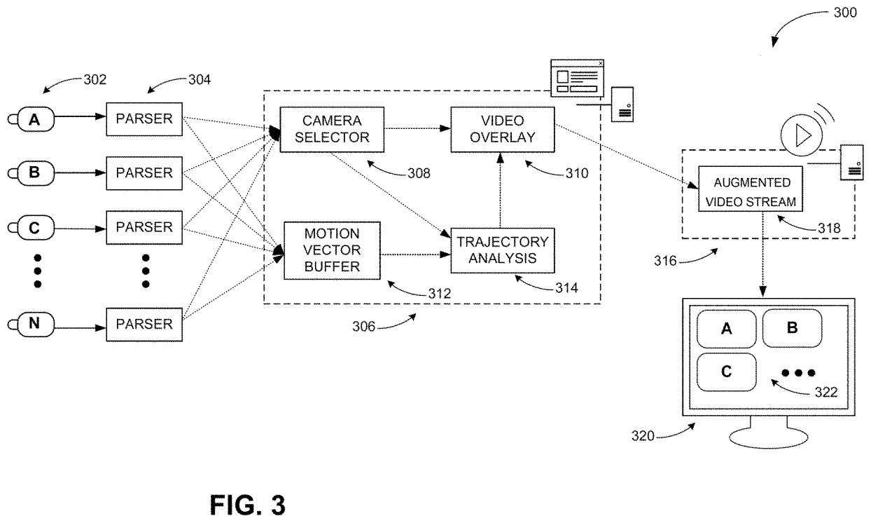

FIG. 3 illustrates example components and interactions in a system for object trajectory augmentation on a newly displayed video stream in surveillance environments, arranged in accordance with at least some embodiments described herein.

An example system as shown in diagram 300 may receive captured videos of a surveillance environment from cameras 302 with different vantage points, for example. Parsers 304 may extract motion vectors for one or more targets from corresponding video streams. The derived motion vectors may be stored in motion vectors buffer 312 of a processing server 306 of the security system. The term “buffer” is used for the storage of motion vectors to indicate a data store that is capable of providing rapid access to store and retrieve data. In a practical surveillance environment, a large number of cameras may provide input. The motion vectors may be derived, stored, and retrieved (for trajectory generation) in real time or near real time. Thus, for practical implementations, a rapid access data storage such as random access memory (RAM), flash memory, or similar data storage types may be used as opposed to magnetic or optical data storage types that may provide large storage capacity, but slow data access. On the other hand, depending on the number of cameras, number of tracked targets, and processing capacity, slower data storage types may also be used in some implementations.

A camera selector 308 may select one or more cameras whose video feed is to be displayed on a display device 320. The display device 320 may be one or multiple display devices in a control center of a security system or a mobile display device integrated to a computing device carried by a security person in the field (e.g., a mobile computer, a wearable computer, a smartphone, etc.). The display device 320 may display video feed from a single selected camera or video feeds 322 from multiple cameras.

A trajectory analysis module or trajectory analyzer 314 may analyze motion vectors in a currently selected video stream and from stored motion vectors (other video streams) to determine a match and generate a trajectory for a target. Motion vectors may be generated during encoding of the video streams and are typically much smaller than encoded video data. Thus, storage and retrieval of the motion vectors (as well as analysis) may be faster than video data such as image analysis. In some examples, partial or complete image analysis may be used to complement the trajectory generation.

The generated trajectory may be overlaid (310) with the selected video stream at the processing server 306 and provided to a media server 316 to be provided to the display device 320 as augmented video stream 318. In other examples, the trajectory and the selected video stream may be provided separately to the media server 316 to be combined by the media server 316 as the augmented video stream 318.

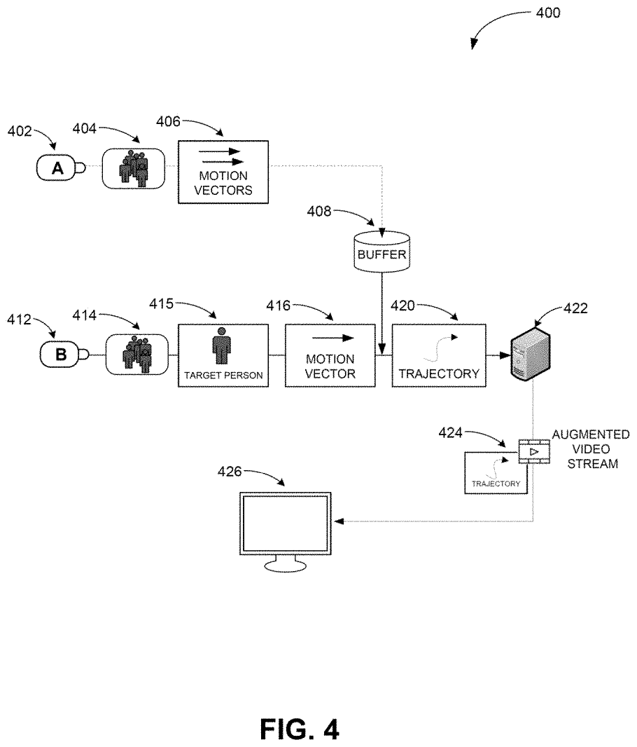

FIG. 4 illustrates conceptually a flow of actions in a system for object trajectory augmentation on a newly displayed video stream in surveillance environments, arranged in accordance with at least some embodiments described herein.

Diagram 400 shows a simplified security system configuration for clarity purposes. In the example system, a camera 402 may capture video of multiple targets 404. Motion vectors 406 for each of the targets 404 in the video from the camera 402 may be extracted and stored in buffer 408. Another camera 412 may also capture video with multiple people 414. A target person 415 may be identified in the captured video of the camera 412 and the motion vector 416 for the target person 415 may be derived. The motion vector 416 may then be compared to stored motion vectors 406 to identify matches and generate a trajectory 420 for the target person 415. The trajectory 420 may be overlaid with the video stream from the camera 412 to generate an augmented video stream 424 by a server 422 and provided to a display device 426.

Motion vectors may be generated based on information about how much the same or almost similar image blocks are moved between consecutive image frames. Therefore, if a motion vector for an image block which includes the target in a selected video stream is tracked over time and accumulated, that motion vector may become the trajectory of the target in some embodiments. In one example, it may be possible to generate a representative motion vector for a target. If a video containing the target includes 10 image blocks, the motion vectors for those 10 image blocks may be averaged and accumulated over time forming the movement trajectory of the target.

To accumulate motion vectors, various approaches may be employed such as connecting motion vectors or connecting a starting point of the oldest motion vector and an ending point of the most recent motion vector. As mentioned above, partial or complete image analysis may be used, in some examples, to complement the motion vector analysis in generation of the trajectory. Moreover, target identification and/or motion vector identification (for an identified target) may include identification and matching of one or more attributes of the target. For example, in case of human targets, a facial feature, a body feature, or a clothing feature may be used as attributes. Shape, size, color, and similar attributes may also be used for other types of targets.

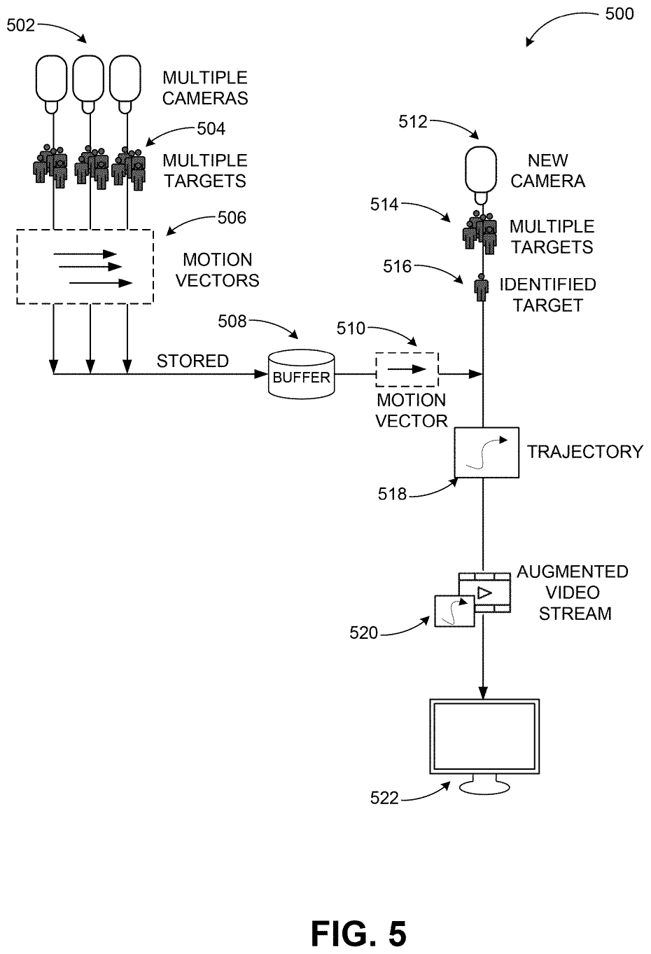

FIG. 5 illustrates an example scenario for implementing object trajectory augmentation on a newly displayed video stream in surveillance environments, arranged in accordance with at least some embodiments described herein.

Diagram 500 shows how multiple cameras 502 in a surveillance system may capture videos of multiple targets 504 (for example, from different vantage points). Motion vectors 506 for those targets may be extracted during encoding of the captured videos and stored in a buffer 508. A newly selected camera 512 may also capture multiple targets 514, among which a target 516 may be identified manually (e.g., by a security personnel) or automatically (e.g., through a facial recognition algorithm). The identified target's motion vector 510 may be compared to stored motion vectors 506 to determine motion vectors associated with the identified target 516.

The determined motion vectors may then be combined to generate a trajectory 518 for the identified target 516. The trajectory 518 may represent a path of the identified target 516 in the past, but may also be extrapolated to generate an expected path in the future. The generated trajectory 518 may be overlaid with a video stream from the selected camera 512 to provide an augmented video stream 520 to a display device 522. In some examples, multiple targets may be identified in a video stream and the augmented video stream may include multiple trajectories for the identified targets.

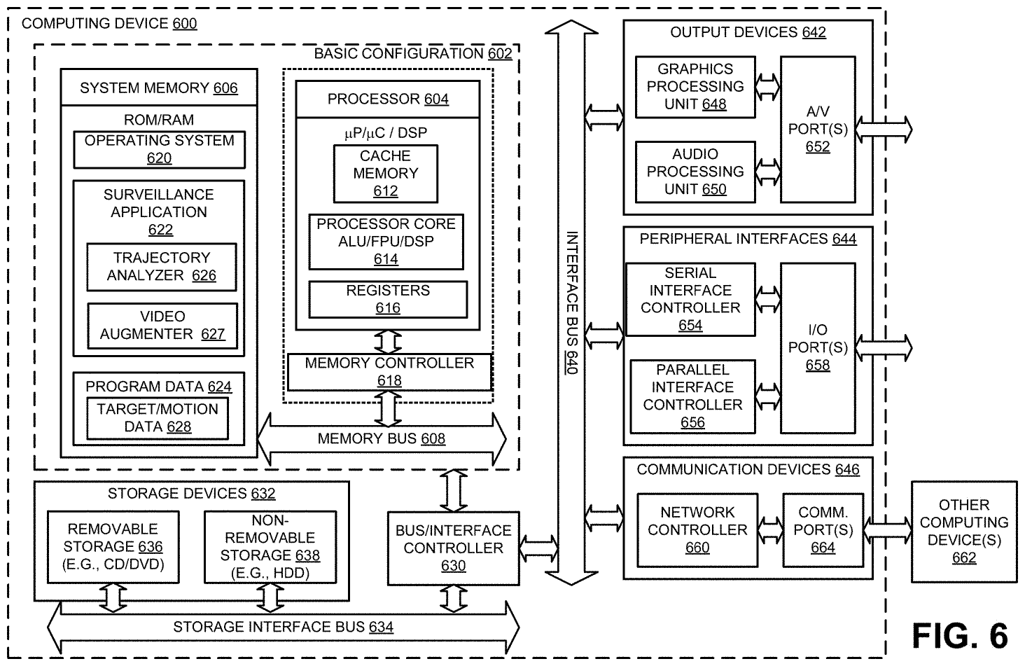

FIG. 6 illustrates a computing device, which may be used for object trajectory augmentation on a newly displayed video stream in surveillance environments, arranged with at least some embodiments described herein.

In an example basic configuration 602, the computing device 600 may include one or more processors 604 and a system memory 606. A memory bus 608 may be used to communicate between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one or more levels of caching, such as a cache memory 612, a processor core 614, and registers 616. The example processor core 614 may include an arithmetic logic unit (ALU), a floating point unit (FPU), a digital signal processing core (DSP core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a surveillance application 622, and program data 624. The surveillance application 622 may include a trajectory analyzer 626 and a video augmenter 627. The surveillance application 622 may be configured to receive a captured video of a surveillance environment and identify a target in the captured video. In conjunction with the trajectory analyzer 626, the surveillance application 622 may also receive motion vectors for a plurality of targets derived from previously captured videos and identify at least one motion vector associated with the identified target among the received motion vectors. The trajectory analyzer 626 may then generate, based on the at least one motion vector, a trajectory for the identified target. The video augmenter 627 may augment the captured video with the trajectory for the identified target. The program data 624 may include, among other data, target and motion data 628 or the like, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (e.g., one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664. The one or more other computing devices 662 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

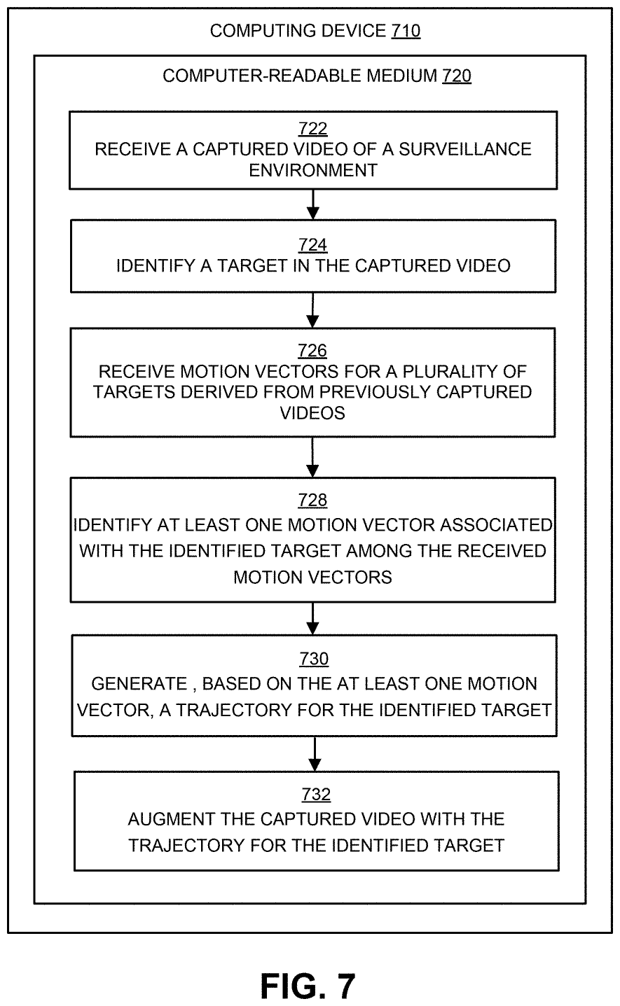

FIG. 7 is a flow diagram illustrating an example method for object trajectory augmentation on a newly displayed video stream in surveillance environments that may be performed by a computing device such as the computing device in FIG. 6, arranged with at least some embodiments described herein.

Example methods may include one or more operations, functions, or actions as illustrated by one or more of blocks 722, 724, 726, 728, 730, and/or 732, and may in some embodiments be performed by a computing device such as the computing device 710 in FIG. 7. Such operations, functions, or actions in FIG. 7 and in the other figures, in some embodiments, may be combined, eliminated, modified, and/or supplemented with other operations, functions or actions, and need not necessarily be performed in the exact sequence as shown. The operations described in the blocks 722-732 may also be implemented through execution of computer-executable instructions stored in a computer-readable medium such as a computer-readable medium 720 of a computing device 710.

An example process for object trajectory augmentation on a newly displayed video stream in surveillance environments may begin with block 722, “RECEIVE A CAPTURED VIDEO OF A SURVEILLANCE ENVIRONMENT”, where a video of a surveillance environment such as a sports arena, a concert venue, a shopping center, or similar place may be received. The video may be captured by image capture devices such as a stationary camera, a mobile camera, a thermal camera, a camera integrated in a mobile device, or a body-mounted camera, for example.

Block 722 may be followed by block 724, “IDENTIFY A TARGET IN THE CAPTURED VIDEO”, where a target to be tracked in the captured video may be identified. Depending on the implementation, the target may be a human, an animal, or a mobile device such as a vehicle, a drone, etc. Identification of the target (in case of human targets) may further include identification of one or more attributes including, but not limited to, a facial feature, a body feature, or a clothing feature.

Block 724 may be followed by block 726, “RECEIVE MOTION VECTORS FOR A PLURALITY OF TARGETS DERIVED FROM PREVIOUSLY CAPTURED VIDEOS”, where stored motion vectors for targets identified in previously captured videos (of the same or similar surveillance areas) may be received. The received motion vectors may be derived from previously captured videos and stored in a data store.

Block 726 may be followed by block 728, “IDENTIFY AT LEAST ONE MOTION VECTOR ASSOCIATED WITH THE IDENTIFIED TARGET AMONG THE RECEIVED MOTION VECTORS”, where a motion vector among the received motion vectors from previously captured videos may be selected as associated with the identified target. The selection/identification of the motion vector may be based on matching of target attributes, deriving a motion vector for the target in the current video and matching that motion vector to one or more of the received motion vectors, etc.

Block 728 may be followed by block 730, “GENERATE, BASED ON THE AT LEAST ONE MOTION VECTOR, A TRAJECTORY FOR THE IDENTIFIED TARGET”, where a trajectory for the identified target may be generated based on the identified motion vector and plotted as a past path and/or an expected future path of the identified target.

Block 730 may be followed by block 732, “AUGMENT THE CAPTURED VIDEO WITH THE TRAJECTORY FOR THE IDENTIFIED TARGET”, where the generated trajectory may be augmented on the current video including the target to indicate a path (past and/or expected) of the target in the surveillance area.

The operations included in the example process are for illustration purposes. Object trajectory augmentation on a newly displayed video stream in surveillance environments may be implemented by similar processes with fewer or additional operations, as well as in different order of operations using the principles described herein. The operations described herein may be executed by one or more processors operated on one or more computing devices, one or more processor cores, specialized processing devices, and/or general purpose processors, among other examples.

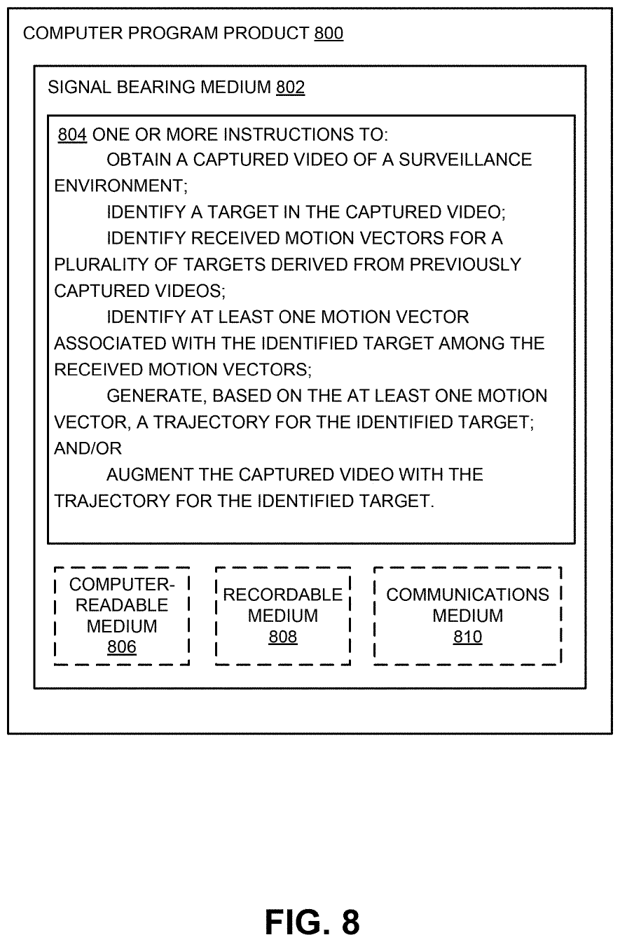

FIG. 8 illustrates a block diagram of an example computer program product, some of which are arranged in accordance with at least some embodiments described herein.

In some examples, as shown in FIG. 8, a computer program product 800 may include a signal bearing medium 802 that may also include one or more machine readable instructions 804 that, in response to execution by, for example, a processor may provide the functionality described herein. Thus, for example, referring to the processor 604 in FIG. 6, the surveillance application 622 may perform or control performance of one or more of the tasks shown in FIG. 8 in response to the instructions 804 conveyed to the processor 604 by the signal bearing medium 802 to perform actions associated with the object trajectory augmentation on a newly displayed video stream in surveillance environments as described herein. Some of those instructions may include, for example, obtain a captured video of a surveillance environment; identify a target in the captured video; identify received motion vectors for a plurality of targets derived from previously captured videos; identify at least one motion vector associated with the identified target among the received motion vectors; generate, based on the at least one motion vector, a trajectory for the identified target; and/or augment the captured video with the trajectory for the identified target, according to some embodiments described herein.

In some implementations, the signal bearing medium 802 depicted in FIG. 8 may encompass computer-readable medium 806, such as, but not limited to, a hard disk drive (HDD), a solid state drive (SSD), a compact disc (CD), a digital versatile disk (DVD), a digital tape, memory, etc. In some implementations, the signal bearing medium 802 may encompass recordable medium 808, such as, but not limited to, memory, read/write (R/W) CDs, R/W DVDs, etc. In some implementations, the signal bearing medium 802 may encompass communications medium 810, such as, but not limited to, a digital and/or an analog communication medium (e.g., a fiber optic cable, a waveguide, a wired communication link, a wireless communication link, etc.). Thus, for example, the computer program product 800 may be conveyed to one or more modules of the processor 604 by an RF signal bearing medium, where the signal bearing medium 802 is conveyed by the communications medium 810 (e.g., a wireless communications medium conforming with the IEEE 802.11 standard).

According to some examples, a method to provide trajectory augmentation on a newly displayed video stream is described. The method may include receiving a captured video of a surveillance environment; identifying a target in the captured video; receiving motion vectors for a plurality of targets derived from previously captured videos; identifying at least one motion vector associated with the identified target among the received motion vectors; generating, based on the at least one motion vector, a trajectory for the identified target; and augmenting the captured video with the trajectory for the identified target.

According to other examples, augmenting the captured video with the trajectory for the identified target may include plotting one or more of a past path and an expected future path of the identified target. Identifying the at least one motion vector associated with the identified target may include deriving a motion vector for the identified target from the received video; and matching the received motion vectors to the derived motion vector for the identified target from the received video. The method may also include receiving a plurality of captured videos of the surveillance environment; identifying a plurality of targets in the plurality of captured videos; deriving motion vectors for each of the identified plurality of targets; and storing the derived motion vectors.

According to other examples, augmenting the captured video with the trajectory for the identified target may include plotting one or more of a past path and an expected future path of the identified target. Identifying the at least one motion vector associated with the identified target may include deriving a motion vector for the identified target from the received video; and matching the received motion vectors to the derived motion vector for the identified target from the received video. The method may also include receiving a plurality of captured videos of the surveillance environment; identifying a plurality of targets in the plurality of captured videos; deriving motion vectors for each of the identified plurality of targets; and storing the derived motion vectors. Receiving the plurality of captured videos of the surveillance environment may include receiving a plurality of encoded video streams. The method may also include identifying one or more attributes of the identified plurality of targets; and storing the one or more attributes of the identified plurality of targets.

According to further examples, identifying the one or more received motion vectors associated with the identified target may include receiving the stored one or more attributes of the identified plurality of targets; and matching, based on the one or more attributes, the identified target to one of the identified plurality of targets. The identified target may be a human, an animal, or a mobile object. Where the target is a human, the one or more attributes may include a facial feature, a body feature, or a clothing feature. Identifying the at least one motion vector may include identifying an image block, in the captured video, that includes the identified target; and identifying, based on the identified image block, the at least one motion vector associated with the identified target. The method may also include identifying, in the captured video, a plurality of image blocks that include the identified target; and determining, based on the identified plurality of image blocks, a plurality of motion vectors associated with the target, where generating the trajectory may include averaging the plurality of motion vectors to generate the trajectory. The method may further include identifying a plurality of motion vectors associated with the target, where generating the trajectory includes combining the plurality of motion vectors.

According to other examples, an apparatus configured to provide trajectory augmentation on a newly displayed video stream is described. The apparatus may include a communication interface configured to facilitate communication between the apparatus, a plurality of cameras in a surveillance environment, and a data store; a plurality of parsers coupled to the communication interface and configured to parse captured video received by the communication interface from the plurality of cameras; and a processor coupled to the communication interface and the plurality of parsers. The processor may be configured to perform or control performance of identify a target in the captured video; receive, through the communication interface, motion vectors for a plurality of targets derived from previously captured videos; identify, among the received motion vectors, at least one motion vector associated with the identified target; generate, based on the at least one motion vector, a trajectory for the identified target; and augment the captured video with the trajectory for the identified target.

According to some examples, the captured video received by the communication interface from the plurality of cameras may include an encoded video stream. To augment the captured video, the processor may be configured to perform or control performance of plot one or more of a past path and an expected future path of the identified target. To identify the at least on motion vector associated with the identified target, the processor may be configured to perform or control performance of derive a motion vector for the identified target from the captured video; and match the received motion vectors to the derived motion vector for the identified target. The processor may be further configured to perform or control performance of receive, through the communication interface, a plurality of captured videos of the surveillance environment; identify a plurality of targets in the plurality of captured videos; derive motion vectors for each of the identified plurality of targets; and store the derived motion vectors.

According to yet other examples, the processor may be further configured to perform or control performance of identify one or more attributes of the identified plurality of targets; and store the one or more attributes of the identified plurality of targets. To identify the at least one motion vector associated with the identified target, the processor may be configured to perform or control performance of match, based on the one or more attributes, the identified target to one of the identified plurality of targets. The identified target may be a human, an animal, or a mobile object. Where the target is a human, the one or more attributes may include a facial feature, a body feature, or a clothing feature. The processor may be configured to perform or control performance of identify an image block, in the captured video, that includes the identified target; and determine, based on the identified image block, the at least one motion vector. The processor may be configured to perform or control performance of identify a plurality of image blocks, in the captured video, that include the identified target; determine, based on the identified plurality of image blocks, a plurality of motion vectors associated with the identified target; and average the plurality of motion vectors associated with the identified target to generate the trajectory. The processor may also be configured to perform or control performance of combine the plurality of motion vectors associated with the identified target to generate the trajectory.

According to further examples, a surveillance system configured to provide trajectory augmentation on a newly displayed video stream is described. The system may include a plurality of surveillance cameras in a surveillance environment; a data store configured to store surveillance related data; a workstation communicatively coupled to the plurality of surveillance cameras and to the data store, where the workstation includes a display device configured to display feeds from the plurality of surveillance cameras and the surveillance related data from the data store; and a server communicatively coupled to and configured to control the plurality of surveillance cameras, the data store, and the workstation. The server may include a communication interface configured to facilitate communication with the plurality of surveillance cameras, the data store, and the workstation; and a processor coupled to the communication interface. The processor may be configured to perform or control performance of receive, through the communication interface, a captured video of the surveillance environment; identify a target in the captured video; receive, through the communication interface, motion vectors for a plurality of targets derived from previously captured videos; identify, among the received motion vectors, at least one motion vector associated with the identified target; generate, based on the at least one motion vector, a trajectory for the identified target; and augment the captured video with the trajectory for the identified target.

According to some examples, the processor may be further configured to perform or control performance of provide, through the communication interface, the augmented captured video to the workstation to be displayed. To augment the captured video, the processor may be configured to perform or control performance of plot one or more of a past path and an expected future path of the identified target. To identify the at least on motion vector associated with the identified target, the processor may be configured to perform or control performance of derive a motion vector for the identified target from the captured video; and match the received motion vectors to the derived motion vector for the identified target. The processor may be further configured to perform or control performance of receive, through the communication interface, a plurality of captured videos of the surveillance environment; identify a plurality of targets in the plurality of captured videos; derive motion vectors for each of the identified plurality of targets; and store the derived motion vectors.

According to yet other examples, the processor may be further configured to perform or control performance of identify one or more attributes of the identified plurality of targets; and store the one or more attributes of the identified plurality of targets. To identify the at least one motion vector associated with the identified target, the processor may be configured to perform or control performance of match, based on the one or more attributes, the identified target to one of the identified plurality of targets. The identified target may be a human, an animal, or a mobile object. Where the target is a human, the one or more attributes may include a facial feature, a body feature, or a clothing feature. The processor may be configured to perform or control performance of identify an image block, in the captured video, that includes the identified target; and determine, based on the identified image block, the at least one motion vector. The processor may be configured to perform or control performance of identify a plurality of image blocks, in the captured video, that include the identified target; determine, based on the identified plurality of image blocks, a plurality of motion vectors associated with the identified target; and average the plurality of motion vectors associated with the identified target to generate the trajectory. The processor may also be configured to perform or control performance of combine the plurality of motion vectors associated with the identified target to generate the trajectory.

There are various vehicles by which processes and/or systems and/or other technologies described herein may be effected (e.g., hardware, software, and/or firmware), and the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and designing the circuitry and/or writing the code for the software and/or firmware would be possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only, and is not intended to be limiting.

In addition, the mechanisms of the subject matter described herein are capable of being distributed as a program product in a variety of forms, and an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation no, such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method to provide trajectory augmentation on a newly displayed video stream, the method comprising:
receiving a captured video of a surveillance environment;
identifying a target in the captured video;
receiving motion vectors for a plurality of targets derived from previously captured videos;
identifying at least one motion vector associated with the identified target among the received motion vectors;
generating, based on the at least one motion vector, a trajectory for the identified target; and
augmenting the captured video with the trajectory for the identified target.

2. The method of claim 1, wherein augmenting the captured video with the trajectory for the identified target comprises:
plotting one or more of a past path and an expected future path of the identified target.

3. The method of claim 1, wherein identifying the at least one motion vector associated with the identified target comprises:
deriving a motion vector for the identified target from the received video; and
comparing the received motion vectors to the derived motion vector for the identified target to determine a match.

4. The method of claim 1, further comprising:
receiving a plurality of captured videos of the surveillance environment;
identifying a plurality of targets in the plurality of captured videos;
deriving motion vectors for each of the identified plurality of targets; and
storing the derived motion vectors.

5. (canceled)

6. The method of claim 4, further comprising:
identifying one or more attributes of the identified plurality of targets; and
storing the one or more attributes of the identified plurality of targets.

7. The method of claim 6, wherein identifying the one or more received motion vectors associated with the identified target comprises:
receiving the stored one or more attributes of the identified plurality of targets; and
matching, based on the one or more attributes, the identified target to one of the identified plurality of targets, wherein the one or more attributes comprise a facial feature, a body feature, or a clothing feature.

8. The method of claim 1, wherein identifying the target in the captured video comprises:
identifying one of a human, an animal, and a mobile object.

9. (canceled)

10. (canceled)

11. The method of claim 1, further comprising:
identifying, in the captured video, a plurality of image blocks that include the identified target; and
determining, based on the identified plurality of image blocks, a plurality of motion vectors associated with the target, wherein generating the trajectory includes averaging the plurality of motion vectors to generate the trajectory.

12. The method of claim 1, further comprising:
identifying a plurality of motion vectors associated with the target, wherein generating the trajectory includes combining the plurality of motion vectors.

13. An apparatus configured to provide trajectory augmentation on a newly displayed video stream, the apparatus comprising:
a communication interface configured to facilitate communication between the apparatus, a plurality of cameras in a surveillance environment, and a data store;
a plurality of parsers coupled to the communication interface and configured to parse a captured video received by the communication interface from one of the plurality of cameras; and
a processor coupled to the communication interface and the plurality of parsers, wherein the processor is configured to perform or control performance of:
identify a target in the captured video;
receive, through the communication interface, motion vectors for a plurality of targets derived from previously captured videos;
identify, among the received motion vectors, at least one motion vector associated with the identified target;
generate, based on the at least one motion vector, a trajectory for the identified target; and
augment the captured video with the trajectory for the identified target, wherein the trajectory includes one or more of a past path and an expected future path of the identified target.

14. (canceled)

15. (canceled)

16. The apparatus of claim 13, wherein to identify the at least one motion vector associated with the identified target, the processor is configured to perform or control performance of:
derive a motion vector for the identified target from the captured video; and
match the received motion vectors to the derived motion vector for the identified target.

17. The apparatus of claim 16, wherein the processor is further configured to perform or control performance of:
receive, through the communication interface, a plurality of captured videos of the surveillance environment;
identify a plurality of targets in the plurality of captured videos;
derive motion vectors for each of the identified plurality of targets;
identify one or more attributes of the identified plurality of targets, wherein the one or more attributes comprise a facial feature, a body feature, or a clothing feature; and
store the derived motion vectors and the one or more attributes of the identified plurality of targets.

18. (canceled)

19. The apparatus of claim 17, wherein to identify the at least one motion vector associated with the identified target, the processor is configured to perform or control performance of:
match, based on the one or more attributes, the identified target to one of the identified plurality of targets.

20. The apparatus of claim 13, wherein the processor is configured to identify the target as one of a human, an animal, and a mobile object.

21. (canceled)

22. The apparatus of claim 13, wherein the processor is configured to perform or control performance of:
identify an image block, in the captured video, that includes the identified target; and
determine, based on the identified image block, the at least one motion vector; or
identify a plurality of image blocks, in the captured video, that include the identified target;
determine, based on the identified plurality of image blocks, a plurality of motion vectors associated with the identified target; and
average the plurality of motion vectors associated with the identified target to generate the trajectory.

23. (canceled)

24. The apparatus of claim 13, wherein the processor is configured to perform or control performance of:
combine the plurality of motion vectors associated with the identified target to generate the trajectory.

25. A surveillance system configured to provide trajectory augmentation on a newly displayed video stream, the system comprising:
a plurality of surveillance cameras in a surveillance environment;
a data store configured to store surveillance related data;
a workstation communicatively coupled to the plurality of surveillance cameras and to the data store, wherein the workstation comprises a display device configured to display feeds from the plurality of surveillance cameras and the surveillance related data from the data store; and
a server communicatively coupled to and configured to control the plurality of surveillance cameras, the data store, and the workstation, wherein the server comprises:
a communication interface configured to facilitate communication with the plurality of surveillance cameras, the data store, and the workstation; and
a processor coupled to the communication interface, wherein the processor is configured to perform or control performance of:
receive, through the communication interface, a captured video of the surveillance environment;
identify a target in the captured video;
receive, through the communication interface, motion vectors for a plurality of targets derived from previously captured videos;
identify, among the received motion vectors, at least one motion vector associated with the identified target;
generate, based on the at least one motion vector, a trajectory for the identified target;
augment the captured video with the trajectory for the identified target, wherein the trajectory includes one or more of a past path and an expected future path of the identified target; and
provide, through the communication interface, the augmented captured video to the workstation to be displayed.

26. (canceled)

27. (canceled)

28. The system of claim 25, wherein to identify the at least one motion vector associated with the identified target, the processor is configured to perform or control performance of:
derive a motion vector for the identified target from the captured video; and
match the received motion vectors to the derived motion vector for the identified target.

29. The system of claim 28, wherein the processor is further configured to perform or control performance of:
receive, through the communication interface, a plurality of captured videos of the surveillance environment;
identify a plurality of targets in the plurality of captured videos;
derive motion vectors for each of the identified plurality of targets; and
store the derived motion vectors.

30. (canceled)

31. (canceled)

32. (canceled)

33. (canceled)

34. The system of claim 25, wherein the processor is configured to perform or control performance of:
identify an image block, in the captured video, that includes the identified target; and
determine, based on the identified image block, the at least one motion vector.

35. The system of claim 25, wherein the processor is configured to perform or control performance of:
identify a plurality of image blocks that include the identified target in the captured video;
determine, based on the identified plurality of image blocks, a plurality of motion vectors associated with the identified target; and
average the plurality of motion vectors associated with the identified target to generate the trajectory.

36. (canceled)
